(19) United States
(12) Patent Application Publication
(10) Pub. No.: US 2019/0354970 A1
(43) Pub. Date: Nov. 21, 2019

(54) CRYPTOGRAPHIC TRANSACTION SIGNING DEVICES AND METHODS THEREFOR

(71) Applicant: DECENTRAL INC., TORONTO (CA)

(72) Inventors: ANTHONY DI IORIO, TORONTO (CA); RICHARD MOORE, TORONTO (CA)

(21) Appl. No.: 15/980,053

(22) Filed: May 15, 2018

(51) Int. Cl. G06Q 20/38; H04L 9/14; H04L 9/30; H04L 9/08; G06F 1/16; H04L 9/32; G06Q 20/06; G06Q 20/36

(52) U.S. Cl. CPC G06Q 20/3825; H04L 9/14; H04L 9/30; H04L 9/0869; G06F 1/1656; G06Q 2220/00; G06Q 20/3829; G06Q 20/065; G06Q 20/3678; G06Q 20/3823; H04L 9/3231

(57) ABSTRACT

A transaction signing system provides a secure manner for signing cryptographically secure data (e.g. cryptographic transaction tracked on distributed ledger systems). An intermediate computing device communicates with a cryptographic transaction processing system and distributed ledger system over a communications network. The intermediate device transmits unsigned transaction data to a transaction signing device through optical over the air communication via an optical output device. The transaction signing device is configured to receive the unsigned transaction data, sign the data using a private key stored on device and transmit signed transaction data optically over the air to the intermediate computing device. The transaction signing device has no other communications systems and is isolated from other communication networks. The intermediate device communicates the signed transaction data to the cryptographic transaction processing system to execute the transaction without exposing the sensitive data stored on the transaction signing device to the communications network.

### CROSS REFERENCE

This disclosure is related to Applicant's U.S. patent application Ser. No. ______, filed ______, having attorney docket number T8480315US and entitled “Cryptographic Transaction Processing System and Client Wallet and Methods Therefor”, the contents of which are incorporated herein by reference.

### FIELD

This disclosure relates to devices and methods to facilitate the cryptographic signing of transactions, more particularly transactions occurring on distributed ledgers and/or transactions of cryptocurrencies.

### BACKGROUND

There are various known cryptocurrency transaction signing devices, also known as “hardware wallets”, which store cryptocurrency keys and execute the cryptographic signing of cryptocurrency transactions. Existing cryptocurrency hardware wallets may connect directly to an intermediate computing device, which in turn is connected to a cryptocurrency blockchain via a communications network (e.g. the Internet). The direct connections between hardware wallet and intermediate computing device include, for example, connections via universal serial bus ports, Bluetooth, and/or near-field communication systems. Connecting the hardware wallet to the network-connected intermediate computing device through such direct connections provide an attack vector for malicious parties to acquire the keys stored on the device and steal the cryptocurrencies linked to said keys.

### SUMMARY

A cryptographic transaction signing system provides a secure manner for signing cryptographically secure data (e.g. cryptographic transaction tracked on distributed ledger systems). An intermediate computing device communicates with a cryptographic transaction processing system and distributed ledger system over a communications network. The intermediate device transmits unsigned transaction data to an air gapped transaction signing device through optical over the air communication via an optical output device. The transaction signing device is configured to receive the unsigned transaction data, sign the data using a private key stored on device and transmit signed transaction data optically over the air to the intermediate computing device. The transaction signing device has no other communications systems and is isolated from other communication networks. The intermediate device communicates the signed transaction data to the cryptographic transaction processing system to execute the transaction without exposing the sensitive data stored on the transaction signing device to the communications network.

There is provided A transaction signing device, comprising a processor, an optical input device, an optical output device, and a memory each in communication with the processor, the memory storing instructions, which when executed by the processor, configure the device to: store one or more private key and public key pairs with which to perform cryptographic transactions; receive, via the optical input device, unsigned transaction data; generate signed transaction data by signing the unsigned transaction data using a private key of the one or more private key and public key pairs; and transmit the signed transaction data using the optical output device.

The optical input device and the optical output device may comprise the only communication components of the transaction signing device, such that the device is incapable of connection to a communications network.

The optical input device may comprise a camera and the optical output device may comprise a display screen and the unsigned transaction data may comprise an image and the signed transaction data may comprise an image.

The signed transaction data may be transmitted using the optical output device to optically communicate the signed transaction data to an intermediate computing device configured to communicate the signed transaction data electronically to perform the cryptographic transactions. The unsigned transaction data may be received from the intermediate computing device. The intermediate computing device may be configured to provide a cryptocurrency wallet with which to perform the cryptographic transactions.

The device may further comprise a second input device to receive input wherein the input is at least one of a) a confirmation whether the device should generate the signed transaction data and b) a cryptographic key seed with which to generate at least some of the private key and public key pairs. The second input device may be a key pad or a touchscreen.

The device may be further configured to: store a cryptographic key seed; and generate at least some of the one or more private key and public key pairs based on the cryptographic key seed. The device may further comprise a random number generator and be configured to: generate one or more random numbers, via the random number generator; and generate the cryptographic key seed based on the one or more random numbers.

The device may further comprise a body housing the processor, the optical input device, the optical output device, and the memory, wherein the body is at least one of water-resistant and fire-resistant.

The device may be configured to generate power using a solar source. At least some of the cryptographic transactions are a transfer of cryptocurrency.

There is provided a computer implemented method comprising: storing, in memory of a transaction signing device, one or more private key and public key pairs with which to perform cryptographic transactions; receiving, by an optical input device of the transaction signing device, unsigned transaction data; generating, by the signing device, signed transaction data by signing the unsigned transaction data using a private key of the one or more private key and public key pairs; and transmitting, by an optical output device of the signing device, the signed transaction data.

The optical input device and the optical output device may comprise the only communication components of the transaction signing device, such that the transaction signing device is incapable of connection to a communications network.

The signed transaction data may be transmitted by the optical output device to optically communicate the signed transaction data to an intermediate computing device configured to communicate the signed transaction data electronically to perform the cryptographic transaction. The unsigned transaction data may be received from the intermediate computing device. The intermediate computing device may be configured to provide a cryptocurrency wallet with which to perform the cryptographic transactions.

The method may further comprise: extracting, by the transaction signing device, the unsigned transaction data from an encoded image, where the unsigned transaction data is received as the encoded image.

The signed transaction data may be displayed on the optical output device as an encoded image.

The method may further comprise: receiving from a second input device of the transaction signing device, at least one of a) a confirmation whether the signing device should generate the signed transaction data and b) a cryptographic key seed with which to generate at least some of the private key and public key pairs. The confirmation may comprise one of a password, a PIN or a biometric input identifying an individual. The method may further comprise receiving the cryptographic key seed via the optical input device as an image encoding the cryptographic key seed or the second input device.

The method may further comprise: storing, by the transaction signing device, a cryptographic key seed; and generating, by the transaction signing device, at least some of the one or more private key and public key pairs based on the cryptographic key seed. The method may further comprise: generating one or more random numbers, via a random number generator of the transaction signing device; and generating, by the transaction signing device, the cryptographic key seed based on the one or more random numbers. The method may further comprise displaying, by the transaction signing device, the cryptographic key seed on the optical output device where the optical output device comprises a display screen.

There is provided a computing device comprising a processor, a memory, a first optical input device, a first optical output device and a communication unit each in communication with the processor. The memory stores instructions, which when executed by the processor, configure the computing device to: optically transmit, via the first optical output device, unsigned transaction data to a transaction signing device; optically receive, via the first optical input device, signed transaction data from the signing device; and communicate via the communication unit over a communication network with a cryptographic transaction processing system to perform cryptographic transactions. The transaction signing device is configured to sign the unsigned transaction data using a private key stored on the signing device to generate the signed transaction data and the transaction signing device comprises a second optical input device and a second optical output device to communicate with the computing device, the second optical input device and the second optical output device comprising the only communication components of the transaction signing device, such that the transaction signing device is incapable of connection to a communications network.

The instructions may configure the computing device to provide a cryptocurrency wallet, the cryptocurrency wallet configured to optically transmit and optically receive with the transaction signing device.

Only the transaction signing device may store the private key for signing the unsigned transaction data.

The instructions may configure the computing device to: generate a cryptographic key seed; optically transmit, via the first optical output device, the cryptographic key seed to the transaction signing device to enable generation of one or more private key and public key pairs; and delete the cryptographic key seed from the computing device.

The signed transaction data may be received as an encoded image and the instructions may configure the computing device to extract the signed transaction data from the encoded image.

The unsigned transaction data may displayed on the first optical output device as an encoded image.

The instructions may configure the computing device to: store a master public key based on a cryptographic key seed; and generate one or more public keys with which to perform the cryptographic transactions. The instructions may configure the computing device to: optically receive, via the first optical input device, the master public key from the transaction signing device, where the transaction signing device is configured to transmit the master public key, via the second optical output device.

### BRIEF DESCRIPTION OF DRAWINGS

FIG. 1 is an illustration of a cryptographic transaction computing system according to one example.

FIG. 2 is a block diagram of an intermediate computing device of FIG. 1 in accordance with an embodiment.

FIG. 3 is a block diagram of the transaction signing device of FIG. 1 in accordance with an embodiment.

FIG. 4 is a flowchart showing an exemplary cryptographic transaction signing operation of the signing device in FIGS. 1 and 2.

FIG. 5 is a flowchart showing an exemplary cryptographic transaction signing operation of the signing device in FIGS. 1 and 2, wherein the unsigned transaction data and the signed transaction data are received and transmitted, respectively, as encoded images.

FIG. 6 is a flowchart showing an exemplary cryptographic transaction signing operation of the signing device in FIGS. 1 and 2, wherein the signing device receives confirmation via in input device.

FIG. 7 is a flowchart showing an exemplary cryptographic key generation operation of the signing device in FIGS. 1 and 2, wherein the singing device receives a cryptographic key seed via an optical input device as an encoded image, or via an input device.

FIG. 8 is a flowchart showing an exemplary cryptographic key generation operation of the signing device in FIGS. 1 and 2, wherein the singing device generates a cryptographic key seed based on one or more random numbers from a random number generator.

While references to “an embodiment” or “an example” are used herein, nothing should be implied or understood that features of one embodiment cannot be used or combined with features of another embodiment unless otherwise stated. The various devices and methods shown and described herein may be used together unless otherwise stated.

### DESCRIPTION

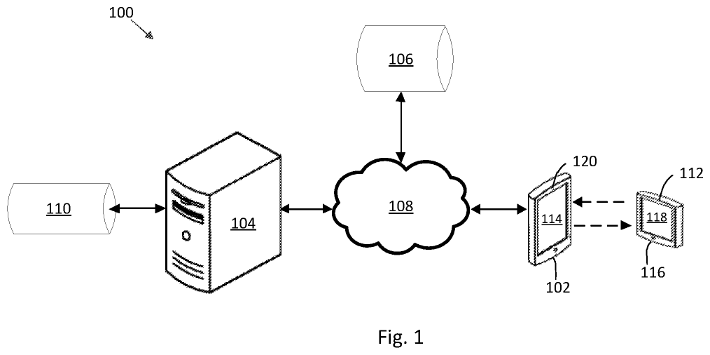

FIG. 1 is an illustration of a cryptographic transaction computing system 100 in accordance with an embodiment. The cryptographic transaction computing system 100 comprises a number of components such as computing systems or computing devices in communication as further described herein. Components include an intermediate computing device 102 in communication with a cryptographic transaction processing system 104 which communicates transactions on behalf of device 102 to a distributed ledger computing system managing a distributed ledger (collectively 106). Distributed ledger computing system and distributed ledger 106 represent a public blockchain that usually comprises a plurality of computing nodes operating together to provide the blockchain. Examples of such blockchains include the Bitcoin blockchain and the Ethereum™ blockchain. Users of these blockchains may perform cryptographic transactions to transfer cryptocurrency between users. Respective cryptocurrency coins or tokens exist on top of each blockchain, an example of a coin is a bitcoin which is a unit of transaction within the Bitcoin blockchain. Within the Ethereum blockchain, the unit is Ether™; however, the Ethereum blockchain also has tokens which are variables within computer programs running in the Ethereum Virtual Machine. Distributed ledger 106 comprises many nodes, each with a copy of the ledger and is shown in a simplified manner in FIG. 1.

The present embodiment shows cryptographic transaction processing system 104 in communication with a data store 110. Data store 110 may store distributed ledger data from distributed ledger computing system and distributed ledger 106. It may also store client data related to device 102.

Intermediate computing device 102, as an intermediary, may communicate with components 104 and 106 via a communication network (108) such as a wide area network (WAN), a public network (e.g. the Internet) or via a private network or a combination of same. Communications within cryptographic transaction processing system 104 may be via a private network and/or public network. Any of the communications between these components 102, 104 and 106 may be via wired or wireless means. These devices typically communicate electronically using wire or radio (wireless) components using well known protocols (e.g. Internet Protocols (IP)). Device 102 is typically configured as a client computing device, as further described below, capable of communicating transaction data for a cryptographic transaction. Components 102, 104 and 106 are typically dispersed in different physical (geographical) locations and are not local to one another. Components which comprise systems 104 and 106 may also be geographically remote from one another. Such components 102, 104 and 106 are often connected to a network or networks for long periods of time and may engage in various communications over the network. Software applications, operating systems and other configurations as well as user behaviour can make these components susceptible to malicious attacks or other malicious activity. It may be desirable to store certain data, such as a private key, on a computing device to sign cryptographic transactions, where the computing device storing such data remains isolated from the communication network 108.

Intermediate computing device 102 is shown in communication with a transaction signing device 112. Signing device 112 comprises an “air gapped” computing device having a special configuration as described further herein. Broken lines between device 102 and signing device 112 represent an optical over the air (OTA) communication path. Signing device 112 is configured to receive unsigned transaction data optically OTA, sign the data using a private key stored on signing device 112 and transmit signed transaction data optically OTA to device 102. In this way, signing device 112 is isolated from other communication networks, particularly communication networks such as 108. Signing device 112 is configured without additional communication components for external communications, for example without antenna or external bus connectors, etc. as further described. In one example, the optical OTA communication comprises displaying an image on an optical output device 114 (e.g. a display screen) of device 102 and capturing an image using an optical input device 116 (e.g. a camera) of signing device 112. Signing device 112 may communicate to device 102 by displaying an image on optical output device 118 (e.g. a display screen) for capture by an optical input device 120 (e.g. s camera). In another example, the optical input devices 116, 120 and optical output devices 114, 118 may be infrared sensors and transmitters.

System 100 shows a single intermediate computing device 102 and a single distributed ledger system and distributed ledger 106. However, cryptographic transaction processing system 104 may be configured to communicate with a plurality of intermediate computing devices, for example, thousands or more. Cryptographic transaction processing system 104 may be configured to communicate with a plurality of different blockchains provided by different distributed ledger systems and distributed ledgers, of which different distributed ledger system and distributed ledger 106 is one example. Each intermediate computing device 102 may be configured to perform transactions via system 104 with more than one respective blockchain of the plurality of different blockchains. Each transaction signing device 112 may be configured to sign transactions on more than one respective blockchain of the plurality of different blockchains. In some examples there may be more than one Intermediate computing device 102. Signing device 112 may receive unsigned transaction data optically OTA from a first intermediate computing device 102 and transmit the signed transaction data optically OTA to a second intermediate computing device 102.

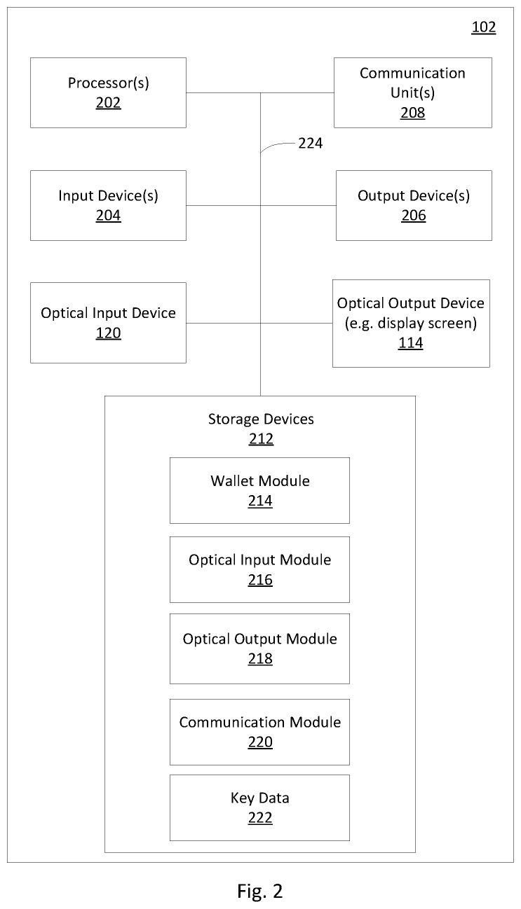

FIG. 2 is a block diagram of the intermediate computing device 102 of FIG. 1 in accordance with an embodiment. Device 102 comprises one or more processors 202, one or more input devices 204 as well as an optical input device 120. Input devices may be a keyboard, key pad, buttons, pointing device, microphone, etc. Optical input device 120 may comprise a camera or an IR sensor (receiver). If the optical input device 120 is an IR sensor, one of the input devices may be a camera or device 102 may have more than one camera. Device 102 comprises one or more output devices 206 as well as an optical output device 114. Output devices may include a speaker, light, bell, vibratory device, etc. Optical output device 114 may be a display screen or an IR transmitter or a projector. Device 102 may have more than one display screen. It is understood that a display screen used in device 102 may be configured as an input device as well, for example, a gesture based device for receiving touch inputs according to various known technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

Intermediate computing device 102 comprises one or more communication units 208 (e.g. Antenna, induction coil, external buses (e.g. USB, etc.), etc.) for communicating via one or more networks but not with signing unit 112.

Intermediate computing device 102 further comprises one or more storage devices 212. The one or more storage devices 212 may store instructions and/or data for processing during operation of device 102. The one or more storage devices may take different forms and/or configurations, for example, as short-term memory or long-term memory. Storage devices 212 may be configured for short-term storage of information as volatile memory, which does not retain stored contents when power is removed. Volatile memory examples include random access memory (RAM), dynamic random access memory (DRAM), static random access memory (SRAM), etc. Storage devices 212, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Storage devices 212 store instructions and/or data for device 102, which instructions when executed by the one or more processors 202 configure the device 102. Instructions may be stored as modules such as a wallet module 214 for performing cryptographic transactions (e.g. transfers of cryptocurrency), optical input module 216, optical output module 218 and communications module 220. Communications module 220 may provide communications capabilities using communication units 208 to communicate with component 104 or other computing devices (not shown). Other modules are not shown such as an operating system, etc. Storage devices 212 store data such as key data 222 as described further.

Communication channels 224 may couple each of the components 114, 120, 202, 204, 206, 208, 212, 214, 216, 218, 220 and 222 for inter-component communications, whether communicatively, physically and/or operatively. In some examples, communication channels 224 may include a system bus, a network connection, an inter-process communication data structure, or any other method for communicating data.

In the examples herein, intermediate computing device 102 is a mobile phone. Other examples of intermediate computing device 102 may be a tablet computer, a personal digital assistant (PDA), a laptop computer, a tabletop computer, a portable gaming device, a portable media player, an e-book reader, a watch, a personal computer or workstation or another type of computing device.

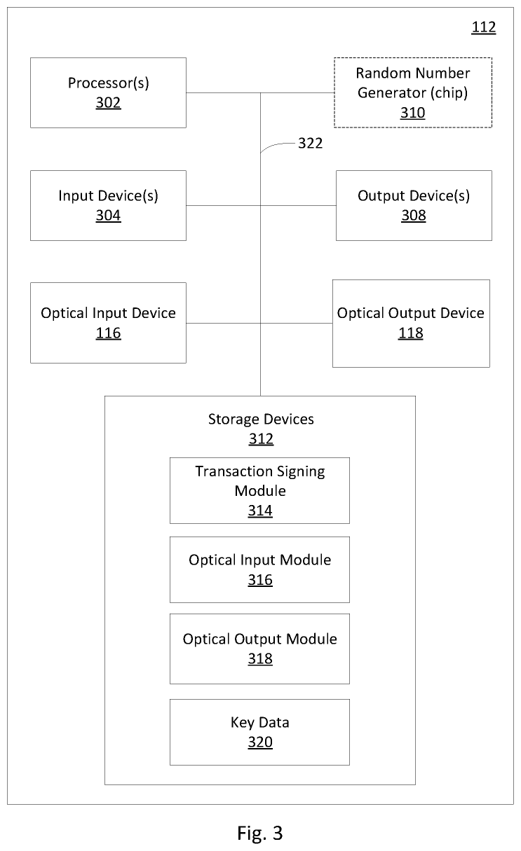

FIG. 3 is a block diagram of a transaction signing device 112 of FIG. 1 in accordance with an embodiment. Signing device 112 is an example of a computing device having limited functionality so as to keep signing device 112 isolated from computer networks and devices thereon, limiting how the signing device 112 may communicatively couple with another computing device, such as device 102.

Signing device 112 comprises one or more processors 302, one or more input devices 304 as well as an optical input device 116. Input devices may be a keyboard, key pad, buttons, pointing device, microphone, etc. in this small form factor device input devices are typically buttons. Optical input device 116 may comprise a camera or an IR sensor (receiver). If the optical input device 116 is an IR sensor, one of the input devices may be a camera or signing device 112 may have more than one camera. Device 112 may comprise one or more output devices 308 as well as an optical output device 118. Output devices may include a speaker, light, bell, vibratory device, etc. Optical output device 118 may be a display screen or an IR transmitter or a projector. Device 112 may have more than one display screen. It is understood that a display screen used in signing device 112 may be configured as an input device as well, for example, a gesture based device for receiving touch inputs according to various known technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display). Given a preferred small form factor, the number and type of input and output devices may be limited to keep the device to a desired size and cost at the expense of limiting other functionality. Signing device 112 may be limited to receiving unsigned transaction data optically OTA, signing the unsigned transaction data using a private key stored to the signing device 112 and transmitting the signed transaction data optically OTA. In other examples it may provide cold storage features, storing certain cryptographic transaction data offline, which data is received optically OTA or by (manual) input.

Unlike device 102, signing device 112 does not comprise one or more communication units (e.g. antenna, induction coil, external bus connectors (e.g. USB, etc.), etc.) for communicating via one or more networks. In embodiments, the one or more input devices 304 and optical output device 116 comprise the only communication components of the transaction signing device 112 such that the device is incapable of connection to a communications network.

Optionally, designated by the broken lines, signing device 112 may comprise a random number generator 310 such as a chip for generating random numbers with which to define key data for cryptographic transactions. Alternatively, the random number generator 310 may be implemented as software stored in the storage devices 312.

Signing device 112 further comprises one or more storage devices 312. The one or more storage devices 312 may store instructions and/or data for processing during operation of signing device 112. The one or more storage devices may take different forms and/or configurations, for example, as short-term memory or long-term memory. Storage devices 312 may be configured for short-term storage of information as volatile memory, which does not retain stored contents when power is removed. Volatile memory examples include random access memory (RAM), dynamic random access memory (DRAM), static random access memory (SRAM), etc. Storage devices 312, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Devices 312 store instructions and/or data for signing device 112, which instructions when executed by the one or more processors 302 configure the signing device 112. Instructions may be stored as modules such as a transaction signing module 314 for performing signing data for cryptographic transactions (e.g. transfers of cryptocurrency), optical input module 316 and optical output module 318. Also stored in devices 312 is key data 320 such as a private key to sign data, a public key or a key seed, as further described herein. Other modules are not shown such as an operating system, etc. The functionality of the OS and modules may be limited to suit the limited functionality of device 312, a special purpose device.

Communication channels 322 may couple each of the components 116, 118, 302, 304, 308, 310, 312, 314, 316, 318 and 320 for inter-component communications, whether communicatively, physically and/or operatively. In some examples, communication channels 322 may include a system bus, a network connection, an inter-process communication data structure, or any other method for communicating data.

Though not shown, the components of transaction signing device 112 are housed in a ruggedized manner so as to be protected against solid objects (e.g. penetration), protected against liquids (e.g. water resistant), protected against mechanical impacts (e.g. drops), and protected against temperature (e.g. low temp and/or high temp resistant). Devices may be configured and/or tested in accordance with one or more standards such as “MIL-STD-810, Environmental Engineering Considerations and Laboratory Tests” and/or NEMA (National Electrical Manufacturers Association) IEC (International Electrotechnical Commission) 60529 Degrees of Protection Provided by Enclosures—IP (Ingress Protection) Code. The device may have an alloy backbone and may employ silicone or other gaskets and selected display glass types and plastics such as nylon, polyether ether ketone (PEEK) and reinforced polycarbonate to provide the desired characteristics.

Signing device 112 may receive power via external or internal sources, such as an external power supply unit, rechargeable or disposable batteries, solar power, or any other source of power configured for a portable electronic device, or combination thereof, including wireless power charging. It may be advantageous to include an on board power generation capability, such as an integrated solar power generation unit that is enclosed within the body of signing device 112 to provide power to a store (e.g. a battery) or an electrical load (components of signing device 112). The body may have photovoltaic cells coupled to the integrated solar power generation unit to generate electricity. Maintaining a closed power system further prevents the device from being attacked or damaged through its power system (e.g. via an accidental or intentional power surge). In embodiments, signing device 112 may include an induction coil and related integrated power generation components solely configured to charge a power store (e.g. a battery) and which coil and components are isolated from communicating data, for example, to or via the one or more processors 302 and any data storage devices 312.

In the examples herein, transaction signing device 112 is a special purpose device having a small form factor. In an embodiment where the optical output device is a display screen, signing device 112 is sufficiently large and any display screen of sufficient resolution to display an image encoding signed transaction data (e.g. a 2D barcode) for communicating optically OTA to a camera of a device 102.

Wallet module 214 of the intermediate computing device 102 may implement a deterministic wallet and preferably a hierarchical deterministic (HD) wallet. Wallet module 214 may provide an implementation compliant with various Bitcoin Improvement Proposals (BIPs) such as BIP 32—Hierarchical Deterministic Wallets published at https://github.com/bitcoin/bips/blob/master/bip-0032.mediawiki; BIP 39—Mnemonic code for generating deterministic keys published at https://github.com/bitcoin/bips/blob/master/bip-0032.mediawiki; and BIP 44—Multi-account hierarchy for deterministic wallets published at https://github.com/bitcoin/bips/blob/master/bip-0044.mediawiki each of which is incorporated herein by reference.

In some examples, wallet module 214 of the intermediate computing device 102 generates the key data 222. The private key data of key data 222 generated may be input into transaction signing device 112 for storing as key data 320. It may be deleted from device 102. It may be communicated optically OTA from device 102 to signing device 112 such as by encoding the key data in an encoded image, displaying the image on the optical output device 114 (e.g. display screen) and receiving the encoded image at signing device 112 via the optical input device 116 (e.g. camera). In other examples it may be transmitted using IR signals between the devices. Key data may include seed data for generating specific keys. Seed data may be represented as mnemonics and displayed via optical output device 114. This seed data may be optically communicated OTA to signing device 112 for reading by a camera. OCR techniques may be used to determine the characters. In other examples, the mnemonics may be input such as by typing or by voice input. The mnemonics may be used to generate binary key seed data to generate keys for deterministic wallets.

In some examples, transaction signing device 112 may generate the key data 320 for a wallet (e.g. key seed and one or more pairs of public and private keys) and may use a random number generator 310 for example. It may be communicated optically OTA from signing device 112 to device 102 such as by encoding the key data in an encoded image, displaying the image on the optical output device 118 (e.g. display screen) and receiving the encoded image at device 102 via the optical input device 120 (e.g. camera). In other examples it may be transmitted using IR signals between the devices. Key data may include seed data for generating specific keys. Seed data may be represented as mnemonics and displayed via optical output device 118. This seed data may be optically communicated OTA to signing device 112 for reading by a camera. OCR techniques may be used to determine the characters. In other examples, the mnemonics may be input such as by typing or by voice input. The mnemonics may be used to generate binary key seed data to generate keys for deterministic wallets.

Key generation for deterministic wallets is known to those of skill in the art and the function(s) therefor is(are) described in BIP 32. The representation of cryptographic key seed data as mnemonics is well known and described in BIP 39. Transaction signing device 112 may implement all or a portion of such BIPs for key generation. In accordance with the key derivation specification, deterministic wallets comprise one or more chains of keypairs of public and private keys. A single chain may comprise a practically infinite number (billions) of keypairs with which transactions may be conducted. The BIP 32 specification provides operations to generate a number of child keys from a parent key. The parent key is extended (with bits of entropy) and functions applied to define a chain of keypairs, both private and public. Importantly, given a parent extended key and an index i, it is possible to compute the corresponding child extended key, where i is the index in the chain of keypairs. Thus a parent extended public key (referenced as an xPub) may be shared with another device so that the xPub may be used to generate child extended public keys. These child extended public keys are useful as transaction addresses for cryptographic transactions. For security purposes, sharing a private key is not suggested as it gives a receiving device the ability to conduct a transaction (e.g. sign unsigned transaction data). Thus sharing a private key with another device is suggested to be restricted to sharing with devices that are under a same user control or other trusted control. However, BIP32 does provide a specification which permits a full wallet sharing among devices, for example, where both wallets wish to be able to perform spending through sharing a xPriv, the parent extended private key.

Thus in accordance with an embodiment of the teachings herein where transaction signing device 112 generates the key data, the xPriv and xPub keys may be generated by signing device 112 and the xPub key shared with device 102. In another embodiment where device 102 or another device generates the key data, xPriv is generated elsewhere (e.g. device 102 or another wallet device) and shared with signing device 112. The corresponding xPub may also be shared, for example, for storage. Similarly a key seed such as a mnemonic may be generated by signing device 112 or shared with it and stored thereon for later regenerating keys, as may be applicable.

In some examples, wallet module 214 of the intermediate computing device 102 may operate to generate unsigned transaction data. Unsigned transaction data may comprise one or more inputs, and one or more outputs. Each of the one or more inputs may be an output from a previous transaction on the distributed ledger 106. The unsigned transaction data may further comprise a public key of a private key and public key pair, such that a cryptographic signature generated for the transaction using the private key of the private key and public key pair can be verified via the public key associated with the transaction. Wallet module 214 may request confirmation from a user whether the unsigned transaction data should be transmitted to another device (i.e. signing device 112) for signing, via the output devices 206 and/or the optical output device 114. User may provide confirmation, via the input devices 204 and/or the optical input device 120. Confirmation may require the user to press a button, enter a password, a PIN, or provide a biometric input identifying an individual (i.e. the user). Wallet module 214 may provide the unsigned transaction data to optical output module 218 via communication channels 224.

In some examples, optical output module 218 may operate in communication with the optical output device 114 to transmit the unsigned transaction data to signing device 112, optionally in an encoded form. In some examples optical output module 218 may further operate to encode the signed transaction data prior to transmitting via the optical output device. Unsigned transaction data may be communicated optically OTA from device 102 to signing device 112 such as by encoding the key data in an encoded image, displaying the image on the optical output device 114 (e.g. display screen) and receiving the encoded image at signing device 112 via the optical input device 116 (e.g. camera). In other examples it may be transmitted using IR signals between the devices.

In some examples, optical input module 316 of signing device 112 may operate in communication with optical input device 116 to retrieve, as described above, unsigned transaction data transmitted via optical output module 218 of device 102. Optical input module 316 may further operate to extract the unsigned transaction data retrieved in an encoded form. Optical input module 316 may provide the unsigned transaction data to the transaction signing module 314 via the communication channels 322.

In some examples, transaction signing module 314 may request confirmation from a user via the output devices 308 and/or the optical output device 118. User may provide confirmation whether the transaction signing module 314 should proceed to cryptographically sign the transaction, via the input devices 304 and/or the optical input device 116. Confirmation may require the user to press a button, enter a password, enter a PIN, or provide a biometric input identifying the user. Transaction signing module 314 may cryptographically sign unsigned transaction data using any cryptographic signing method known in the art for public key cryptography, such as via an elliptical curve digital signature algorithm. Cryptographic signing of data in a public key cryptography system is well known in the art. Transaction signing module 314 may provide the signed transaction data to the optical output module 318 via communication channels 322.

In some examples, optical output module 318 may operate in communication with the optical output device 118 to transmit the signed transaction data to device 102, optionally in an encoded form. Optical output module 318 may further operate to encode the signed transaction data prior to transmitting via the optical output device. Signed transaction data may be communicated optically OTA from signing device 112 to device 102 such as by encoding the key data in an encoded image, displaying the image on the optical output device 118 (e.g. display screen) and receiving the encoded image at device 102 via the optical input device e.g. (camera). In other examples it may be transmitted using IR signals between the devices.

In some examples, optical input module 216 of device 102 may operate in communication with optical input device 120 to retrieve, as described above, signed transaction data transmitted via optical output module 318 of signing device 112. Optical input module 216 may further operate to extract the signed transaction data retrieved in an encoded form. Optical input module 216 may provide the signed transaction data to wallet module 214 and/or communications module 220 via communication channels 224.

Communications module 220 may operate in conjunction with communication units 208 to broadcast the signed transaction data to the cryptographic transaction processing system 104 and/or the distributed ledger computing system and distributed ledger 106 via the communication network 108.

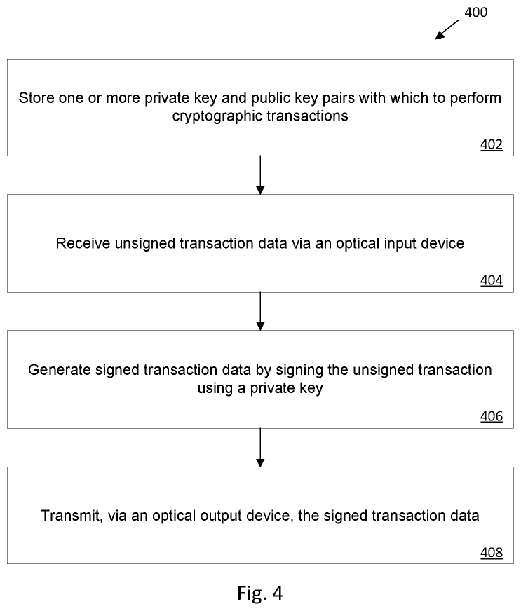

FIGS. 4-8 are flowcharts showing illustrations of various operations of selected components of the cryptographic transaction computing system of FIG. 1.

FIG. 4 is a flowchart showing an illustration of an exemplary cryptographic transaction signing operation 400 of the signing device 112. Signing device 112 and the method described facilitates the cryptographic signing of a transaction while securely storing the sensitive key data 320 on signing device 112 which is not in communication with communication network 108. Storage devices 312 of the signing device 112 may store instructions, which when executed by the processors 302, configure the signing device 112 to perform operations 400 as shown in FIG. 4. At 402, the signing device 112 stores in the storage devices 312 key data 320, for example one or more private key and public key pairs with which to perform cryptographic transactions, said private key and public key pairs being generated as further disclosed herein. At 404, the signing device 112 receives unsigned transaction data via the optical input device 120. At 406, the signing device 112 generates signed transaction data by signing the unsigned transaction data with a private key of one or more private key and public key pairs stored on the storage devices 312. At 408, the signing device 112 transmits the signed transaction data, via the optical output device 118.

In an exemplary cryptographic transaction signing procedure, a user generates unsigned transaction data via wallet module 214 of device 102. As further described herein, device 102 transmits the unsigned transaction data via optical output device 114. Optical input device 116 of signing device 112 receives the unsigned transaction data. Signing device 112 generates signed transaction data by signing the unsigned transaction data with a private key of the private key and public key pairs stored as key data 320. Signing device 112 transmits the signed transaction data via optical output device 118. Device 102 receives the signed transaction data via optical input device 120 and transmits the signed transaction data, via the communication network 108, to the cryptographic transaction processing system 104 and/or the distributed ledger computing system and distributed ledger 106.

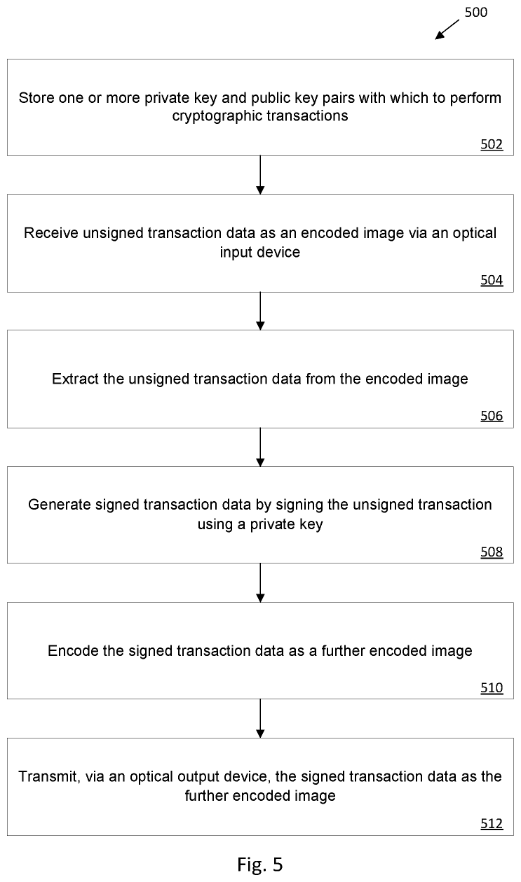

FIG. 5 is a flowchart showing an illustration of an exemplary cryptographic transaction signing operation 500 of the signing device 112. Signing device 112 and the method described facilitates the cryptographic signing of a transaction encoded as an image while securely storing the sensitive key data 320 on signing device 112 which is not in communication with communication network 108. Storage devices 312 of the signing device 112 may store instructions, which when executed by the processors 302, configure the signing device 112 to perform operations 500 as shown in FIG. 5. At 502, the signing device 112 stores in the storage devices 312 key data 320, for example one or more private key and public key pairs with which to perform cryptographic transactions, said private key and public key pairs being generated as further disclosed herein. At 504, the signing device 112 receives unsigned transaction data as an encoded image (e.g. a QR code) via the optical input device 120. At 506, the signing device extracts the unsigned transaction data from the encoded image. At 508, the signing device 112 generates signed transaction data by signing the unsigned transaction data with a private key of one or more private key and public key pairs stored on the storage devices 312. At 510, the signing device 112 encodes the signed transaction data as a further encoded image (e.g. a QR code). At 512, the signing device 112 transmits the signed transaction data as the further encoded image, via the optical output device 118.

In an exemplary cryptographic transaction signing procedure, the process proceeds as described in the exemplary procedure for FIG. 4. However, device 102 encodes the unsigned transaction data as an encoded image. Device 102 transmits said encoded image via the optical output device 114. Signing device 112 receives the unsigned transaction data, via the optical input device 116, as the encoded image. Signing device 112 extracts the unsigned transaction data and generates the signed transaction data. Signing device 112 encodes the signed transaction data as a further encoded image and transmits the further encoded image, via the optical output device 118, to device 102. Device 102 receives the further encoded image, via the optical input device 120, extracts the signed transaction data and transmits the signed transaction data, via the communication network 108, to the cryptographic transaction processing system 104 and/or the distributed ledger computing system and distributed ledger 106.

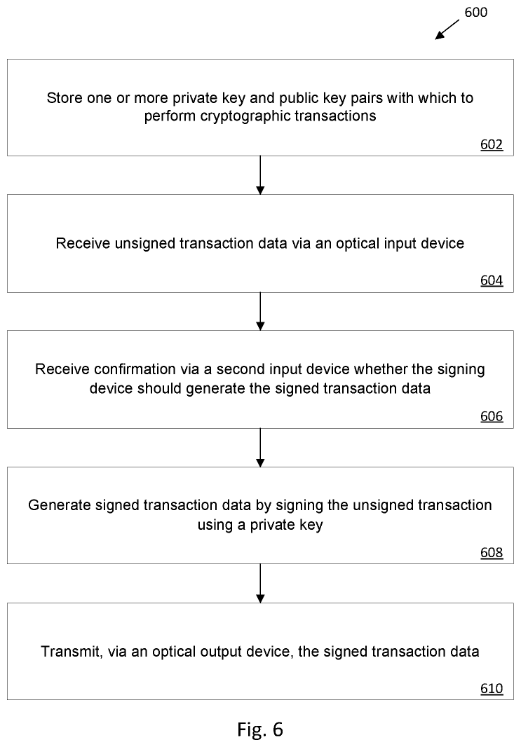

FIG. 6 is a flowchart showing an illustration of an exemplary cryptographic transaction signing operation 600 of the signing device 112. Signing device 112 and the method described facilitates the cryptographic signing of a transaction, subject to confirmation from a user, while securely storing the sensitive key data 320 on signing device 112 which is not in communication with communication network 108. Storage devices 312 of the signing device 112 may store instructions, which when executed by the processors 302, configure the signing device 112 to perform operations 600 as shown in FIG. 6. At 602 the signing device 112 stores in the storage devices 312 key data 320, for example one or more private key and public key pairs with which to perform cryptographic transactions, said private key and public key pairs being generated as further disclosed herein. At 604, the signing device 112 receives unsigned transaction data via the optical input device 120. At 606, the signing device 112 receives confirmation via the further input devices 304 whether the signing device 112 should proceed to generate the signed transaction data. At 608, the signing device 112 generates signed transaction data by signing the unsigned transaction data with a private key of one or more private key and public key pairs stored on the storage devices 312. At 610, the signing device 112 transmits the signed transaction data, via the optical output device 118.

In an exemplary cryptographic transaction signing procedure, the process proceeds as described in the exemplary procedure for FIG. 4 or FIG. 5. However, prior to generating the signed transaction data, signing device 112 requests confirmation whether to proceed from a user via output devices 308 and/or the optical output device 118. User provides confirmation as further described herein, via the input devices 304 and/or the optical input device 116.

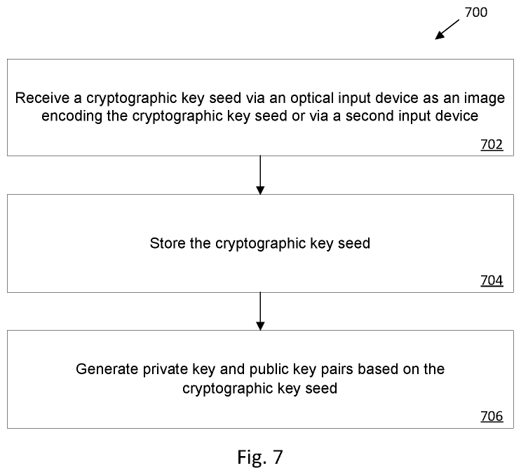

FIG. 7 is a flowchart showing an illustration of an exemplary cryptographic key generation operation 700, to be executed by the signing device 112 as an initialization operation. Signing device 112 and the method described facilitates the generation and storing of sensitive key data 320 on signing device 112 which is not in communication with communication network 108. Storage devices 312 of the signing device 112 may store instructions, which when executed by the processors 302, configure the signing device 112 to perform operations 700 as shown in FIG. 7. At 702, the signing device 112 receives a cryptographic key seed via the optical input device 120 as an image encoding the cryptographic key seed or via the input devices 304. At 704 the signing device 112 stores the cryptographic key seed in the storage devices 312 as seed data. At 706, the signing device 112 generates key data 320, for example private key and public key pairs, based on the cryptographic key seed stored as seed data.

This cryptographic key generation operation 700 may be used, for example, where it is desired to transfer the key data 320 from an existing wallet to the signing device 112 or to restore key data 320 in the event of failure of device 112.

In an exemplary cryptographic key generation procedure, an uninitialized signing device 112 prompts a user, via the output devices 308 and/or the optical output device 118 to provide a cryptographic key seed to the signing device 112. In another embodiment the user commences the procedure to provide a cryptographic key seed to the signing device 112, for example to reset the device and provide a new cryptographic key seed, or to provide an additional cryptographic key seed to be stored on the storage devices 312 of the signing device 112.

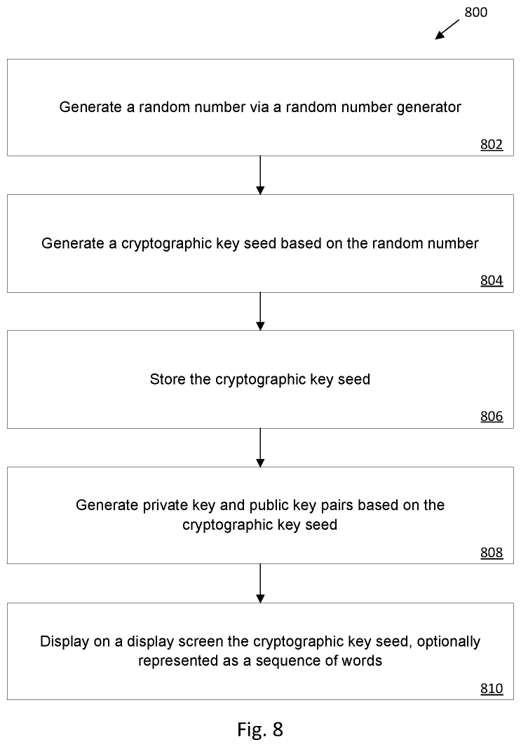

FIG. 8 is a flowchart showing an illustration of an exemplary cryptographic key generation operation 800, to be executed by the signing device 112 as an initialization operation. Signing device 112 and the method described facilitates the generation and storing of sensitive key data 320 on signing device 112 which is not in communication with communication network 108. Storage devices 312 of the signing device 112 may store instructions, which when executed by the processors 302, configure the signing device 112 to perform operations 800 as shown in FIG. 8. At 802, the signing device 112 generates one or more random numbers. The random numbers may be generated via the random number generator 310. At 804, the signing device 112 generates a cryptographic key seed based on the one or more random numbers. At 806, the signing device 112 stores the cryptographic key seed in the storage devices 312 as seed data. At 808, the signing device 112 generates key data 320, for example private key and public key pairs, based on the cryptographic key seed stored as seed data. At 810, the signing device 112 displays via the optical output device 118 (display) the seed data, which may optionally be represented as an encoded sequence of words, as further disclosed herein.

This cryptographic key generation operation 800 may be used, for example, where it is desired to create an entirely new set of key data 320 on the signing device 112, unrelated to an existing wallet. The seed data may be displayed such that a user can record the mnemonic representing the seed data to facilitate restoring the seed data in the event of a failure in the signing device 112, or the seed data may be transferred to another device (i.e. 102) as further disclosed herein. The key data, or a portion thereof, may be transferred to another device (i.e. 102) for storage as further disclosed herein.

In an exemplary cryptographic key generation procedure, an uninitialized signing device 112 prompts a user, to commence the cryptographic key generation operation 800 on the signing device 112 via the output devices 308 and/or the optical output device 118. In another embodiment the user commences the cryptographic key generation operation 800, for example to reset the device and generate a new cryptographic key seed, or to generate an additional cryptographic key seed to be stored on the storage devices 312 of the signing device 112.

In some examples, the key data may be a master key, from which further private key and public key pairs may be generated, or a master public key, from which only further public keys may be generated, as further disclosed herein.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A transaction signing device, comprising a processor, an optical input device, an optical output device, and a memory each in communication with the processor, the memory storing instructions, which when executed by the processor, configure the device to:
store one or more private key and public key pairs with which to perform cryptographic transactions;
receive, via the optical input device, unsigned transaction data;
generate signed transaction data by signing the unsigned transaction data using a private key of the one or more private key and public key pairs; and
transmit the signed transaction data using the optical output device.

2. The transaction signing device of claim 1 wherein the optical input device and the optical output device comprise the only communication components of the transaction signing device, such that the device is incapable of connection to a communications network.

3. The transaction signing device of claim 1 wherein the optical input device is a camera and the optical output device comprises a display screen and wherein the unsigned transaction data comprises an image and the signed transaction data comprises an image.

4. The transaction signing device of claim 1 wherein the signed transaction data is transmitted using the optical output device to optically communicate the signed transaction data to an intermediate computing device configured to communicate the signed transaction data electronically to perform the cryptographic transactions.

5. The transaction signing device of claim 4 wherein the unsigned transaction data is received from the intermediate computing device.

6. The transaction signing device of claim 4 wherein the intermediate computing device is configured to provide a cryptocurrency wallet with which to perform the cryptographic transactions.

7. The transaction signing device of claim 1 further comprising a second input device to receive input wherein the input is at least one of a) a confirmation whether the device should generate the signed transaction data and b) a cryptographic key seed with which to generate at least some of the private key and public key pairs.

8. The transaction signing device of claim 7 wherein the second input device is a key pad or a touchscreen.

9. The transaction signing device of claim 1 wherein the memory stores further instructions, which when executed by the processor, configure the device to:
store a cryptographic key seed; and
generate at least some of the one or more private key and public key pairs based on the cryptographic key seed.

10. The transaction signing device of claim 9 further comprising a random number generator, wherein the memory stores further instructions, which when executed by the processor, configure the device to:
generate one or more random numbers, via the random number generator; and
generate the cryptographic key seed based on the one or more random numbers.

11. The transaction signing device of claim 1 further comprising a body housing the processor, the optical input device, the optical output device, and the memory, wherein the body is at least one of water-resistant and fire-resistant.

12. The transaction signing device of claim 1 wherein at least some of the cryptographic transactions are a transfer of cryptocurrency.

13. The transaction signing device of claim 1 further comprising a solar power source.

14. A computer implemented method comprising:
storing, in memory of a transaction signing device, one or more private key and public key pairs with which to perform cryptographic transactions;
receiving, by an optical input device of the transaction signing device, unsigned transaction data;
generating, by one or more processors of the transaction signing device, signed transaction data by signing the unsigned transaction data using a private key of the one or more private key and public key pairs; and
transmitting, by an optical output device of the signing device, the signed transaction data.

15. The method of claim 14 wherein the optical input device and the optical output device comprise the only communication components of the transaction signing device, such that the transaction signing device is incapable of connection to a communications network.

16. The method of claim 14 wherein the signed transaction data is transmitted by the optical output device to optically communicate the signed transaction data to an intermediate computing device configured to communicate the signed transaction data electronically to perform one of the cryptographic transactions.

17. The method of claim 16 wherein the unsigned transaction data is received from the intermediate computing device.

18. The method of claim 16 wherein the intermediate computing device is configured to provide a cryptocurrency wallet with which to perform the cryptographic transactions.

19. The method of claim 14 further comprising extracting, by the transaction signing device, the unsigned transaction data from an encoded image; wherein the unsigned transaction data is received as the encoded image.

20. The method of claim 14 wherein the signed transaction data is displayed on the optical output device as an encoded image.

21. The method of claim 14 further comprising receiving from a second input device of the transaction signing device, at least one of a) a confirmation whether the transaction signing device should generate the signed transaction data and b) a cryptographic key seed with which to generate at least some of the private key and public key pairs.

22. The method of claim 21 wherein the confirmation comprises one of a password, a PIN or a biometric input identifying an individual.

23. The method of claim 21 further comprising receiving the cryptographic key seed via the optical input device as an image encoding the cryptographic key seed or the second input device.

24. The method of claim 14 further comprising:
storing, by the transaction signing device, a cryptographic key seed; and
generating, by the transaction signing device, at least some of the one or more private key and public key pairs based on the cryptographic key seed.

25. The method of claim 24 further comprising:
generating one or more random numbers, via a random number generator of the transaction signing device; and
generating, by the transaction signing device, the cryptographic key seed based on the one or more random numbers.

26. The method of claim 25 further comprising displaying, by the transaction signing device, the cryptographic key seed on the optical output device where the optical output device comprises a display screen.

27. A computing device comprising a processor, a memory, a first optical input device, a first optical output device and a communication unit each in communication with the processor, the memory storing instructions, which when executed by the processor, configure the computing device to:
optically transmit, via the first optical output device, unsigned transaction data to a transaction signing device;
optically receive, via the first optical input device, signed transaction data from the transaction signing device; and
communicate via the communication unit over a communication network with a cryptographic transaction processing system to perform cryptographic transactions;
wherein the transaction signing device is configured to sign the unsigned transaction data using a private key stored on the signing device to generate the signed transaction data; and,
wherein the transaction signing device comprises a second optical input device and a second optical output device to communicate with the computing device, the second optical input device and the second optical output device comprising the only communication components of the transaction signing device, such that the transaction signing device is incapable of connection to a communications network.

28. The computing device of claim 27 wherein the instructions configure the computing device to provide a cryptocurrency wallet, the cryptocurrency wallet configured to optically transmit and optically receive with the transaction signing device.

29. The computing device of claim 27 wherein only the transaction signing device stores the private key for signing the unsigned transaction data.

30. The computing device of claim 27 wherein the instructions configure the computing device to:
generate a cryptographic key seed;
optically transmit, via the first optical output device, the cryptographic key seed to the transaction signing device to enable generation of one or more private key and public key pairs; and
delete the cryptographic key seed from the computing device.

31. The computing device of claim 27 wherein the signed transaction data is received as an encoded image and wherein the instructions configure the computing device to extract the signed transaction data from the encoded image.

32. The computing device of claim 27 wherein the unsigned transaction data is displayed on the first optical output device as an encoded image.

33. The computing device of claim 27 wherein the instructions configure the computing device to:
store a master public key based on a cryptographic key seed; and
generate one or more public keys with which to perform the cryptographic transactions.

34. The computing device of claim 33 wherein the instructions configure the computing device to:
optically receive, via the first optical input device, the master public key from the transaction signing device,
wherein the transaction signing device is configured to transmit the master public key, via the second optical output device.
